(19) United States
(12) Patent Application Publication
(10) Pub. No.: US 2026/0215433 A1
(43) Pub. Date: Jul. 30, 2026

(54) Hybrid Nano-Bio Larvicide Composition and Method for Controlling Culicoides Biting Midges and Mosquitoes

(71) Applicant: Lucas Cole Dollarhite, Mount Pleasant, SC (US)

(72) Inventor: Lucas Cole Dollarhite, Mount Pleasant, SC (US)

(21) Appl. No.: 19/574,838

(22) Filed: Mar. 23, 2026

(51) Int. Cl. A01N 59/16; A01N 25/10; A01N 25/12; A01N 43/40; A01N 63/23; A01P 7/04

(52) U.S. Cl. CPC A01N 59/16; A01N 25/10; A01N 25/12; A01N 43/40; A01N 63/23; A01P 7/04

(57) ABSTRACT

A slow-release biodegradable particulate larvicide composition for controlling larvae of Culicoides biting midges and mosquitoes comprises silver nanoparticles, Bacillus thuringiensis israelensis, a juvenile-hormone-analog insect growth regulator, a chitosan-alginate matrix cross-linked with calcium chloride, and one or more larval attractants and/or carbon-dioxide-releasing components. The composition may be provided as granules or microparticles for application to saline, brackish, intermittently flooded, or other moist larval habitats, including coastal salt-marsh habitats and standing-water sites. The matrix retains the active ingredients in the treatment zone and meters release upon hydration. Also disclosed are methods of preparing the particulate composition and methods of controlling biting-midge and mosquito larvae by applying the composition to larval habitat.

### CROSS-REFERENCE TO RELATED APPLICATIONS

None.

### BACKGROUND OF THE INVENTION

The present invention relates generally to larvicidal compositions and methods for controlling Dipteran insects. More particularly, the invention relates to a slow-release biodegradable particulate composition containing a nanomaterial component, a biological larvicide component, an insect growth regulator component, and an attractant component in a cross-linked chitosan-alginate matrix for controlling Culicoides biting midges and mosquitoes.

Biting midges of the genus Culicoides, including Culicoides furens, are a persistent nuisance in coastal and marsh-associated regions. Mosquitoes may occupy overlapping or adjacent larval habitat. Saline pools, brackish water, intermittently flooded depressions, marsh edges, damp organic substrate, retention ponds, and shallow standing water can support recurring larval development and repeated pest emergence.

Existing control approaches may present limitations. Adulticidal spraying can provide only temporary relief and may not prevent continued emergence from untreated larval habitat. Source reduction may be impractical in marshland, wetland, or environmentally sensitive areas. Single-active larvicides may provide incomplete control, limited persistence, or insufficient interruption of development under saline, tidal, flooding, or dilution-prone conditions.

There remains a need for a biodegradable slow-release larvicide formulation that can be deployed in moist or aquatic larval habitat, that combines complementary modes of action in a single particulate carrier, and that is capable of controlling both Culicoides biting midges and mosquitoes.

### SUMMARY OF THE INVENTION

In one aspect, the invention provides a slow-release biodegradable particulate larvicide composition comprising silver nanoparticles, Bacillus thuringiensis israelensis, a juvenile hormone analog insect growth regulator, a chitosan-alginate polymer matrix, and one or more larval attractants and/or carbon-dioxide-releasing components.

In certain embodiments, the composition comprises, on a total composition weight basis, 8-12% w/w silver nanoparticles having a particle size of 10-50 nm, 8-10% w/w Bacillus thuringiensis israelensis, 1-2% w/w of a juvenile hormone analog insect growth regulator, 75-80% w/w of a chitosan-alginate polymer matrix in which chitosan and alginate are present in a 1:2 ratio and the matrix is cross-linked with calcium chloride, and 3-5% w/w of one or more larval attractants and/or carbon-dioxide-releasing components.

In another aspect, the composition is provided in the form of a slow-release granule or microparticle suitable for broadcast application to larval habitat. In certain embodiments, the particulate composition is provided as granules having a diameter of about 1-3 mm. In other embodiments, the composition is provided as smaller particles or microparticles for broader dispersion in treatment zones.

In another aspect, the silver nanoparticles, biological larvicide, insect growth regulator, and attractants and/or carbon-dioxide-releasing components are retained within a biodegradable cross-linked matrix that localizes the active ingredients in a treatment zone and meters release upon hydration.

In another aspect, the invention provides methods of making the particulate composition by forming a chitosan-alginate precursor, incorporating the active components, shaping the precursor into droplets or particulate precursors, cross-linking the precursor with calcium chloride, and drying the resulting granules or microparticles.

In another aspect, the invention provides methods of controlling larvae of Culicoides biting midges and mosquitoes by applying the particulate composition to moist or aquatic larval habitat, including saline, brackish, intermittently flooded, and standing-water habitats.

### DETAILED DESCRIPTION OF THE INVENTION

The disclosed composition is designed as a slow-release biodegradable particulate larvicide for use in habitats where Culicoides biting midge larvae and mosquito larvae occur in saline, brackish, fresh, or intermittently flooded conditions. The particulate form allows localization of active ingredients in target habitat while the polymeric carrier moderates release over time.

Unless otherwise stated, all percentages are expressed as percent by weight based on total composition weight. The term granule refers to a particulate body suitable for broadcast application. The term microparticle refers to a smaller particulate body formed from the same composition. Both forms are slow-release particulate bodies carried by the same biodegradable matrix system.

As used herein, the term juvenile hormone analog insect growth regulator includes pyriproxyfen and other insect growth regulators having analogous activity in interfering with larval development, metamorphosis, pupation, and/or adult emergence. Pyriproxyfen is presently preferred.

In representative embodiments, the composition has the formulation set forth in Table 1.

### Table 1. Representative Formulation

Silver nanoparticles, 10-50 nm: 8-12% w/w; direct larvicidal component.
Bacillus thuringiensis israelensis: 8-10% w/w; biological larvicide.
Juvenile hormone analog insect growth regulator: 1-2% w/w; developmental interruption.
Chitosan-alginate matrix, 1:2, calcium-chloride cross-linked: 75-80% w/w; biodegradable slow-release carrier.
Larval attractants and/or carbon-dioxide-releasing components: 3-5% w/w; increased larval encounter and interaction.

The polymer matrix is a chitosan-alginate matrix in which chitosan and alginate are present in a 1:2 ratio and cross-linked with calcium chloride. In preferred embodiments, the matrix functions both as a biodegradable carrier and as a release-control medium that retains the active ingredients in the target habitat and moderates their availability over time.

The silver nanoparticle component comprises silver nanoparticles having a particle size of 10-50 nm. Preformed nanoparticles within this size range may be dispersed throughout the polymer precursor so that the nanoparticles become distributed within the final cross-linked particulate body.

The Bacillus thuringiensis israelensis component may be incorporated as a biologically active particulate or powder. In certain embodiments, the Bacillus thuringiensis israelensis component has a potency of at least 3,000 ITU/mg. Processing conditions are selected so that biological activity is substantially preserved through manufacture.

The insect growth regulator component is a juvenile hormone analog insect growth regulator and is preferably pyriproxyfen. This component complements direct larval kill by suppressing normal insect development and adult emergence.

The attractant and/or carbon-dioxide-releasing component is selected so as to be compatible with the polymer matrix and to increase larval interaction with the composition at the treatment site. In some embodiments, the component comprises one or more larval attractants. In other embodiments, the component comprises one or more carbon-dioxide-releasing materials. In still other embodiments, the component comprises both.

In a representative preparation method, an alginate-containing aqueous medium and a chitosan-containing aqueous medium are separately provided and then combined so that the chitosan-to-alginate ratio is 1:2, thereby forming a matrix precursor.

Silver nanoparticles are dispersed into the matrix precursor with mixing sufficient to obtain a substantially uniform distribution. The Bacillus thuringiensis israelensis component and the insect growth regulator component are then incorporated into the precursor. Mixing is controlled so as to maintain a substantially uniform distribution of the active ingredients while preserving biological activity of the Bacillus thuringiensis israelensis component.

The attractant and/or carbon-dioxide-releasing component is incorporated into the active-loaded matrix precursor to form a composite particulate feed.

The composite feed is shaped into droplets, granules, or microparticle precursors and is contacted with calcium chloride so as to cross-link the chitosan-alginate matrix. In representative embodiments, the shaping step comprises extrusion, droplet formation, or spray-based formation of particulate precursors.

The resulting cross-linked particulate bodies may be collected, rinsed, dried, and optionally classified by size. The dried product may be retained as a granule or further processed as a microparticle, depending on the desired field-deployment characteristics.

In certain embodiments, the particulate composition is provided as a granule having a diameter of about 1-3 mm. In other embodiments, the particulate composition is provided as a smaller particle or microparticle suitable for broader dispersion in shallow or mixed larval habitat.

Without wishing to be bound by theory, the silver nanoparticle component is believed to contribute to larval control through interaction with larval tissues and disruption of normal cellular and membrane function. Without wishing to be bound by theory, the Bacillus thuringiensis israelensis component is believed to provide toxin-mediated biological activity against susceptible dipteran larvae. Without wishing to be bound by theory, the insect growth regulator component is believed to interfere with normal development and adult emergence.

The attractant and/or carbon-dioxide-releasing component increases local interaction between larvae and the treated particulate body and thereby enhances delivery of the active ingredients within the target zone.

The cross-linked chitosan-alginate matrix functions as a biodegradable carrier that localizes the active ingredients in the treatment area and provides slow release under wetting, flooding, saline exposure, and related environmental conditions.

The composition is suitable for application to coastal salt-marsh habitat, saline pools, brackish water, intermittently flooded depressions, marsh edges, shallow standing water, damp soil, retention ponds, moist substrate, and related larval habitat in which Culicoides biting midges and mosquito larvae occur.

In representative embodiments, the disclosed composition is applied at a rate of about 5-20 kg/ha. The selected rate may vary with larval density, hydrology, salinity, organic loading, persistence goals, and the degree of dilution or tidal exchange. In smaller treatment areas, the application rate may be scaled according to area and habitat conditions.

Because the composition combines nanomaterial, biological, and insect-growth-regulator activity in one particulate carrier, it is suited for use where Culicoides biting midge larvae and mosquito larvae occur in the same or adjacent habitat.

The disclosed composition provides advantages including localized treatment, multi-mechanism activity, slow release from a biodegradable matrix, and suitability for deployment in complex wet or intermittently flooded habitat.
Example 1—Preferred Granule Formulation. A preferred granule embodiment comprises 10.0% w/w silver nanoparticles having a size of 10-50 nm, 9.0% w/w Bacillus thuringiensis israelensis, 1.5% w/w pyriproxyfen, 76.0% w/w chitosan-alginate matrix in a 1:2 ratio cross-linked with calcium chloride, and 3.5% w/w larval attractants and/or carbon-dioxide-releasing components.

In Example 1, the polymer components are combined to form the matrix precursor, the silver nanoparticles are dispersed into the precursor, the Bacillus thuringiensis israelensis and pyriproxyfen are incorporated, the attractant and/or carbon-dioxide-releasing component is added, and the resulting composite feed is particulate-formed and cross-linked to yield slow-release granules.
Example 2—Microparticle Formulation. A representative microparticle embodiment comprises 8.0% w/w silver nanoparticles having a size of 10-50 nm, 10.0% w/w Bacillus thuringiensis israelensis, 2.0% w/w pyriproxyfen, 75.0% w/w chitosan-alginate matrix in a 1:2 ratio cross-linked with calcium chloride, and 5.0% w/w larval attractants and/or carbon-dioxide-releasing components.

In Example 2, the same general order of addition is used as in Example 1, except that the composite feed is formed into smaller particulate bodies so as to obtain microparticles rather than larger granules.

The disclosed ranges may be selected to emphasize persistence, attraction, direct larval kill, or developmental interruption, while remaining within the expressly disclosed composition and matrix system.

All combinations and subcombinations of the expressly disclosed features are contemplated, provided that they remain consistent with the disclosed particulate composition, the stated component ranges, the 1:2 chitosan-alginate matrix cross-linked with calcium chloride, and the disclosed use for control of Culicoides biting midges and mosquitoes.

1. A slow-release biodegradable particulate larvicide composition for controlling larvae of Culicoides biting midges and mosquitoes, comprising, on a total composition weight basis:
(a) 8-12% w/w silver nanoparticles having a particle size of 10-50 nm;
(b) 8-10% w/w Bacillus thuringiensis israelensis;
(c) 1-2% w/w of a juvenile hormone analog insect growth regulator;
(d) 75-80% w/w of a chitosan-alginate polymer matrix, wherein chitosan and alginate are present in a 1:2 ratio and the matrix is cross-linked with calcium chloride; and
(e) 3-5% w/w of one or more larval attractants and/or carbon-dioxide-releasing components,
wherein the composition is in the form of a slow-release granule or microparticle configured for application to moist or aquatic larval habitat.

2. The composition of claim 1, wherein the insect growth regulator is pyriproxyfen.

3. The composition of claim 1, wherein the Bacillus thuringiensis israelensis has a potency of at least 3,000 ITU/mg.

4. The composition of claim 1, wherein the composition is a granule having a diameter of 1-3 mm.

5. The composition of claim 1, wherein the composition is a microparticle.

6. The composition of claim 1, wherein the attractants and/or carbon-dioxide-releasing components are dispersed within the polymer matrix and are released upon hydration in larval habitat.

7. The composition of claim 1, wherein the composition is configured for broadcast application at 5-20 kg/ha.

8. The composition of claim 7, wherein the larval habitat comprises saline, brackish, intermittently flooded, or standing-water habitat.

9. The composition of claim 8, wherein the larval habitat comprises a coastal salt-marsh habitat.

10. A method of controlling larvae of Culicoides biting midges and mosquitoes, the method comprising applying the composition of claim 1 to moist or aquatic larval habitat in an amount effective to reduce larval survival and/or adult emergence.

11. The method of claim 10, wherein the larval habitat comprises one or more of marsh edges, brackish pools, damp soil, retention ponds, shallow standing water, or intermittently flooded depressions.

12. The method of claim 10, wherein the composition is applied at a rate of 5-20 kg/ha.

13. The method of claim 10, wherein the applying is repeated at intervals selected according to larval pressure, hydrology, and persistence requirements.

14. A method of making a slow-release biodegradable particulate larvicide composition, the method comprising:
(a) providing an alginate-containing aqueous medium and a chitosan-containing aqueous medium;
(b) combining the media to form a chitosan-alginate precursor in which chitosan and alginate are present in a 1:2 ratio;
(c) incorporating silver nanoparticles, Bacillus thuringiensis israelensis, a juvenile hormone analog insect growth regulator, and one or more larval attractants and/or carbon-dioxide-releasing components into the precursor;
(d) shaping the precursor into droplets or particulate precursors; and
(e) contacting the droplets or particulate precursors with calcium chloride to form a cross-linked slow-release granule or microparticle.

15. The method of claim 14, further comprising drying and optionally sizing the cross-linked granules or microparticles.
